(19) United States
(12) Patent Application Publication
(10) Pub. No.: US 2008/0094186 A1
(43) Pub. Date: Apr. 24, 2008

(54) Apparatus and method for monitoring and controlling gate operators via power line communication

(75) Inventors: Daniel Perez, Foothill Ranch, CA (US); Ali Tehranchi, Irvine, CA (US)

Correspondence Address: JAFARI LAW GROUP, P.C., 801 N. PARKCENTER DRIVE, SUITE 220, SANTA ANA, CA, 92705, US

(73) Assignee: Viking Access Systems, LLC

(21) Appl. No.: 11/545,345

(22) Filed: Oct. 4, 2006

(51) Int. Cl. G05B 11/01

(52) U.S. Cl. 340/310.11; 340/5.71

(57) ABSTRACT

The invention is an apparatus and method for controlling, monitoring and upgrading information via a power line that typically only supplies power to a gate operation system. By introducing an electrical signal to a power line along a frequency not used for the purposes of supplying electricity, signals and commands can propagate through a local power grid so that a user, for example a technician, may set, adjust and upgrade parameters of a gate operator in the comfort of a room that shares the same power grid as the gate operation system.

### TECHNICAL FIELD OF THE INVENTION

This invention relates generally to gate operator communication and more particularly the ability to control, monitor and upgrade information pertaining to gate operating system parameters using Power Line Communication (PLC) technology.

### BACKGROUND OF THE INVENTION

Typically, technicians installing movable barrier operators, for example gate operators, perform adjustments of different parameters such as limits of gate operation for the closed and opened positions, time delays, sensor sensitivity levels, directional movement control, and level of voltage during operation.

During adjusting procedures, technicians encounter the task of physically accessing the movable barrier operating system. Thus, the movable barrier operator must be exposed to the technician for proper adjustment of parameters during installation, routine service, troubleshooting service, maintenance, upgrading of information, or any other time the gate operator requires adjustment.

Each time, a technician executes such tasks, he or she must gain access to the control board, usually by removing a cover or gate operator housing, to make the desired adjustments.

Sometimes this creates the need for more than one technician to be present at a particular site, especially if there are multiple gates in different locations on a premise. For example, many locations have multiple sensors located near each gate and gate operator, while other locations may have multiple gate operators in addition to other gate operation devices. A technician servicing such locations would have to individually access each operator's control board to make adjustments or perform maintenance functions. This process may be time consuming and require inefficient use of personnel.

There is a need for a system and method for establishing communication with gate operators to monitor their performance, carry out diagnostic tests and make any desired adjustments without having to physically access the gate operator's control board.

The present invention allows a technician to perform the desired tasks by plugging the monitoring device to any power line on the same power grid as the gate operator. This could very well be, in a guard shack, garage, guest room, a living room, or any other location using the same power grid as the gate operator or device being adjusted.

Once the PLC device is connected to a common power grid, the device will transmit current parameters, settings, adjustments, versions of firmware used by the gate operator, and other similar information over the power line, by using PLC technology.

### SUMMARY OF THE INVENTION

To minimize the limitations found in the prior art, and to minimize other limitations that will be apparent upon the reading of the specification, the present invention provides an apparatus and method for sending and receiving information to and from movable barrier operators, for example gate operators, to allow controlling, monitoring and upgrading information pertaining to parameters of barrier operating systems using Power Line Communication (PLC) capabilities.

One aspect of the present invention is to assist a user, for example an installer, technician, service man or repair man to set, adjust, command, test, troubleshoot, configure, upgrade or monitor a movable barrier operator, for example a gate operator with PLC capabilities, as well as any other device with PLC capabilities connected to the same power grid.

A method for a user to communicate with a movable barrier operator through a power grid comprises the steps of connecting a communication unit, for example a monitoring device, to said power grid, to communicate with said movable barrier operator, receiving a command signal from said user, deriving a control signal from said command signal from said user, and modulating a power line signal to carry said control signal to said movable barrier operator over said power grid.

An apparatus for communicating with a movable barrier operator through a power grid, in accordance with the present invention, comprises of a power grid interface to connect said apparatus to said power grid, a first circuitry configured to receive a command signal, a controller to derive a control signal from said command signal, and a second circuitry configured to modulate a power line signal to carry said control signal to said movable barrier operator over said power grid.

A monitoring device for a user to communicate with a movable barrier operator through a power grid, in accordance with the present invention, comprises a power grid interface to connect said monitoring device to said power grid, a first circuitry configured to receive a command signal from said user, and a controller for deriving a control signal from said command signal, and receiving a response signal from said movable barrier operator, wherein said response signal is carrying a data responsive to said control signal over said power grid. Additionally, a second circuitry is configured for modulating a power line signal to carry said control signal to said movable barrier operator over said power grid, and demodulating said response signal. Finally, said monitoring device further comprises a display configured to present said data in a graphical and alphanumerical format, wherein said data further comprises of a set of information from a sensor connected to said movable barrier operator.

It is an object of the present invention to eliminate the need to physically access the control board of gate operators.

It is another object of the present invention to provide remote access to gate operators through power lines.

It is still another object of the invention to provide installers and manufacturers with a means to set, adjust, command, test, troubleshoot, configure, upgrade or monitor gate operators from a remote location where access to the gate operator's power supply is available.

These and other advantages and features of the present invention are described with specificity so as to make the present invention understandable to one of ordinary skill in the art.

### BRIEF DESCRIPTION OF THE DRAWINGS

FIG. 1 illustrates a basic connection between movable barrier operators, for example gate operators, and a communication unit, for example a monitoring device, in accordance with the present invention.

FIG. 2 illustrates a basic connection between movable barrier operators, for example gate operators, and a communication unit, for example a monitoring device in accordance with another embodiment of the present invention.

FIG. 3 is an exemplary embodiment of a movable barrier operator communication unit, or monitoring device, in accordance with the present invention.

FIG. 4 is an illustration of a block diagram of the various components of monitoring device 300.

FIG. 5 is an illustration of one type of modulation used to send signals over a power line in accordance with an embodiment of the present invention.

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of these various elements and embodiments of the invention.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the invention.

In the following detailed description, a movable barrier operator can be any system that controls a barrier to an entry, an exit, or a view, for example, a gate operator, or a garage door opener. The barrier could be a door or window for a small entity, or a gate for a large entity (i.e. a vehicle), which can swing out, slide open, or even roll upwards. The operator, which moves the barrier or gate from an open position to a closed position and vice-versa, can be manual or automatic.

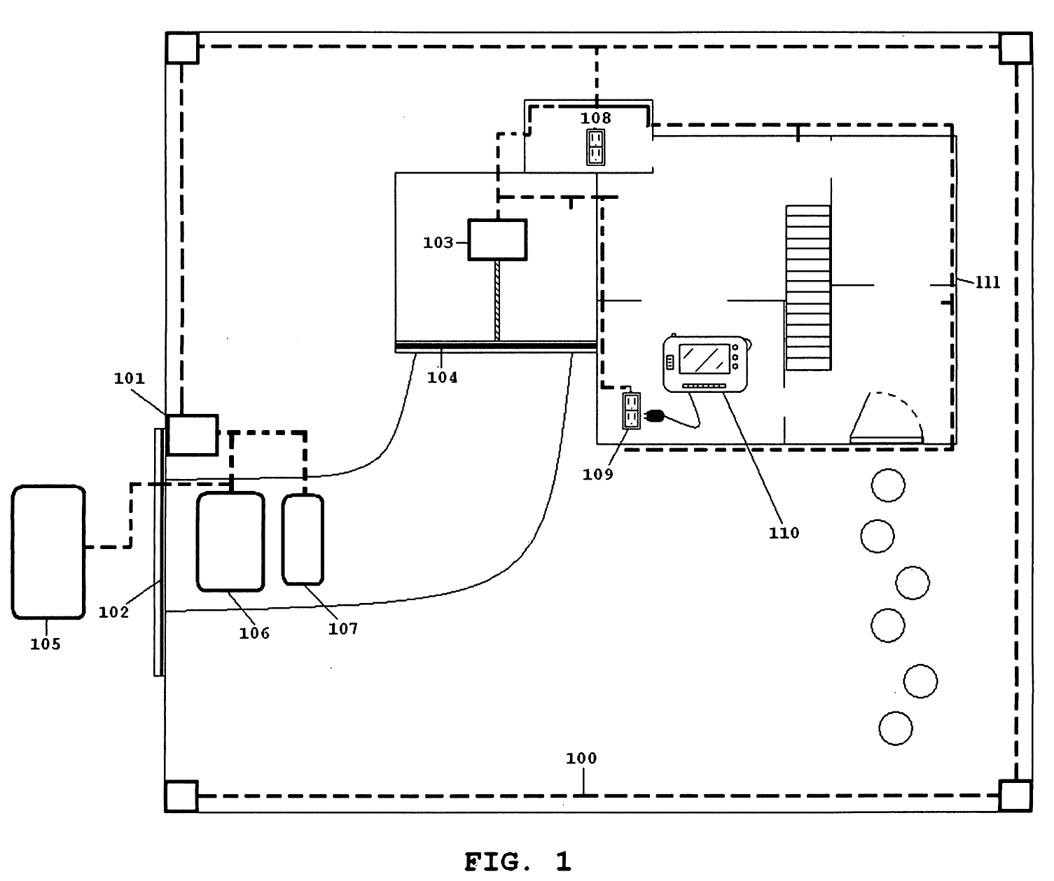

FIG. 1 illustrates a basic connection between movable barrier operators, for example gate operators, and a communication unit, for example a monitoring device, in accordance with the present invention. The illustration shows a home's floor plan depicting power grid 100 to which gate operator 101, gate operator 103, sensors 105, 106, and 107, and monitoring device 110 may be connected to.

Gate operator 101 and sensors 105, 106 and 107 are located near gate 102 in order to control the functions of the main gate to home 111. Gate operator 103 controls gate 104 at the garage of home 111. Several sockets, including socket 108 and socket 109, located throughout home 111 are access points to power grid 100.

Monitoring device 110 is shown near socket 109, located in home 111's living room. However, monitoring device 110 may be plugged in to any socket available in home 111 that has access to power grid 100 including access points that may exist in the exterior of home 111.

Like gate operators 101 and 102, monitoring device 110 may derive power from power grid 100, however, monitoring device 110 may also be battery operated or use both sources of power without limiting the scope of the present invention. In an exemplary embodiment, monitoring device 110 comprises a rechargeable battery so that the device may be operated without the need for a separate power source. In another embodiment, monitoring device 110 also comprises of a power cord that may be extended from monitoring device 110 to access any available power grid such as power grid 100.

Typically, monitoring device 110 injects data via power grid 100 to PLC capable devices. Here, gate operator 101, gate operator 103, and sensors 105, 106, and 107, have been configured to communicate using PLC capabilities.

In one embodiment, once monitoring device 110 powers on, it will poll existing devices for their unique identifier, and will inform the other devices of its own.

In another embodiment, monitoring device 110 sends a command signal through the power grid 100 to gate operators 101 and 103, and gate operators 101 and 103 send back a respond signal or acknowledgment to monitoring device 110. In this fashion, different commands may be sent and received by monitoring device 110 to and from other devices such as sensors 105, 106 and 107, and gate operators 101 and 103. When monitor 110 is plugged into power grid 100, the data injected into power grid 100 requests information from each device.

In one embodiment, a request is automatically injected into the power grid as soon as a connection is made between monitoring device 110 and power grid 100. In another embodiment, the request is not automatic and must be made by a user via the user interface of monitoring device 110.

The data received from each PLC device may be general information about the device or specific information about its current parameters. In an exemplary embodiment, this information may comprise of limits of operation for the close position for each gate operator 101 and 103, limits of operation for the closed position for each operator, time delays for automatic functions such as automatic closing of gates 102 and 104, time delays after sending commands to a device, levels of sensitivity in detecting obstructions, voltage of operation for each device, internal control voltages for different power supplies, and motor parameters such as speed and gate positions.

Once monitoring device 110 receives such information from devices in the field, a user may then send commands to one or multiple PLC capable devices in order to perform tests, make adjustments, or simply synchronize the various devices as desired.

For example, and in no way limiting the scope of the invention, commands that may be exchanged between gate operating devices over a power line may include the following: open gate 102, stop movement of gate 102, close gate 102, reverse movement, or reset parameters for gate 102.

A user may sit in home 111's living room with monitoring device 110 plugged into socket 109. Once monitoring device 110 provides the desired information requested by user, the user may set gate operator 101 and gate operator 103 to open gate 102 and gate 104 (respectively) simultaneously. By communicating with each gate operator 101 and 103, a user can utilize monitoring device 110 to control and set the parameters for each operator, making adjustments to their functions so that their operations are synchronized. Additionally, monitoring device 110 may communicate with each of the sensors 105, 106, and 107 to also be synchronized with gate operator 101 and gate operator 103, so that every time a particular sensor is activated gate operator 103 does not necessarily change the status of gate 104. For example, while some times it may be desirable to have both gates 102 and 104 open at the same time, it might be undesirable for both gates to be activated every time sensor 105 is activated since it is located outside the premise.

In an exemplary embodiment, monitoring device 110 may also perform several other functions or commands to activate devices working in junction with gate operators. For example gate operator 101 and sensor 105 may function jointly along with a device such as an alarm. Monitoring device 110 may then be configured to activate the alarm, to deactivate the alarm, to power on the alarm, to power off the alarm, or to perform any other type of maintenance or service related to that alarm system.

Similarly, monitoring device 110 may be configured to perform other commands: setting a timer delay; setting an overlap delay; read voltage; read a backup battery voltage; read a charging voltage; read an instantaneous motor current; read an instantaneous motor voltage; read a status of all inputs; read a status of all outputs; read a time delay for any device; read an overlap delay; set a code for a keypad; set a master code momentary command; set a master code toggle command; set a time; set a date, send entry codes, and set time for operation.

Naturally, commands available to monitoring device 110 will depend on the type of firmware monitoring device 110 will be utilizing. Typically, firmware versions will depend on the type of devices monitoring device 110 will be servicing, thus monitoring device 110 may be upgraded to perform commands required with particular devices not shown in FIG. 1. In an exemplary embodiment, monitoring device 110 is equipped with firmware that may be upgraded or modified using a USB connection.

Monitoring device should be user friendly. Typically, monitoring device 110 provides the user with data in a fashion that is easily recognizable to a user.

In one embodiment of the present invention, monitoring device 110 comprises of a graphical user interface by which the user can be informed of real time events as they occur. For example, and in no way limiting the scope of the present invention, as a car approaches gate 102 and activates sensor 105, monitoring device 110 provides a graphical representation of the vehicle and the actuation of gate operator 101 opening gate 102, sensor 105, and sensors 106 and 107, as they are activated when the vehicle passes over each one.

In an exemplary embodiment monitoring device 110 is capable of providing graphical and numerical depictions of the internal parameters of the PLC capable devices monitoring device 110 monitors and controls. Such parameters may include power line voltage, battery voltage, internal control board voltages, instantaneous consumption currents for different devices, and gate operator's motor parameters such as speed and position.

In another embodiment, monitoring device 110 does not use graphical representations but text messages on the screen informing the user of real time events as they occur. In yet another embodiment, monitoring device 110 comprises of light indicators that light up when a particular event takes place, for example and without limiting the scope of the present invention, a light might turn on to indicate that gate operator 103 is in the process of closing gate 104 and another light is off indicating that gate operator 101 is currently not moving gate 102. In yet another embodiment, monitoring device 110 uses a combination of graphical representations, text messages, and light indicators to represent data.

In an exemplary embodiment, monitoring device 110 comprises of a user interface capable of providing graphical representations of the actual electromechanical devices being adjusted at the time. A technician will view a screen showing graphical representation of a device the technician is accustomed to and because the information pertaining to the parameters of the actual device are received by monitoring device 110, the graphical representations provided are as accurate and reliable as accessing the physical devices in the field.

For example, monitor 110 may show an illustration of gate operator 101 and gate 102. Since gate operator is communicating with monitoring device 110, the information received will be represented in real time—if gate 102 is slightly opened, monitoring device will show a graphical representation of gate 102 at a position other than the close position. From a remote location, monitoring device 110 may be used to command gate operator 101 to completely close gate 102.

In another exemplary embodiment, monitoring device 110 contains digital controls. In yet another embodiment, monitoring device 110 contains analog controls that represent the analog controls found on an actual device in the field such as with gate operator 101.

In yet another embodiment, monitoring device 110 contains both digital and analog controls without departing from the scope of the present invention.

In one embodiment, monitoring device 110 can be design to communicate with one particular device such as only with one type of model of gate operators without departing from the scope of the present invention. In another embodiment, monitoring device 110 may be custom designed to communicate and function exclusively with one particular client's set of gate operators, barriers, sensors, and other PLC capable devices in that client's premise. This may be useful in occasions where a client such as an industrial size client, may have multiple gates or barriers and several PLC capable devices that require constant synchronization, adjustment, upgrades, and maintenance.

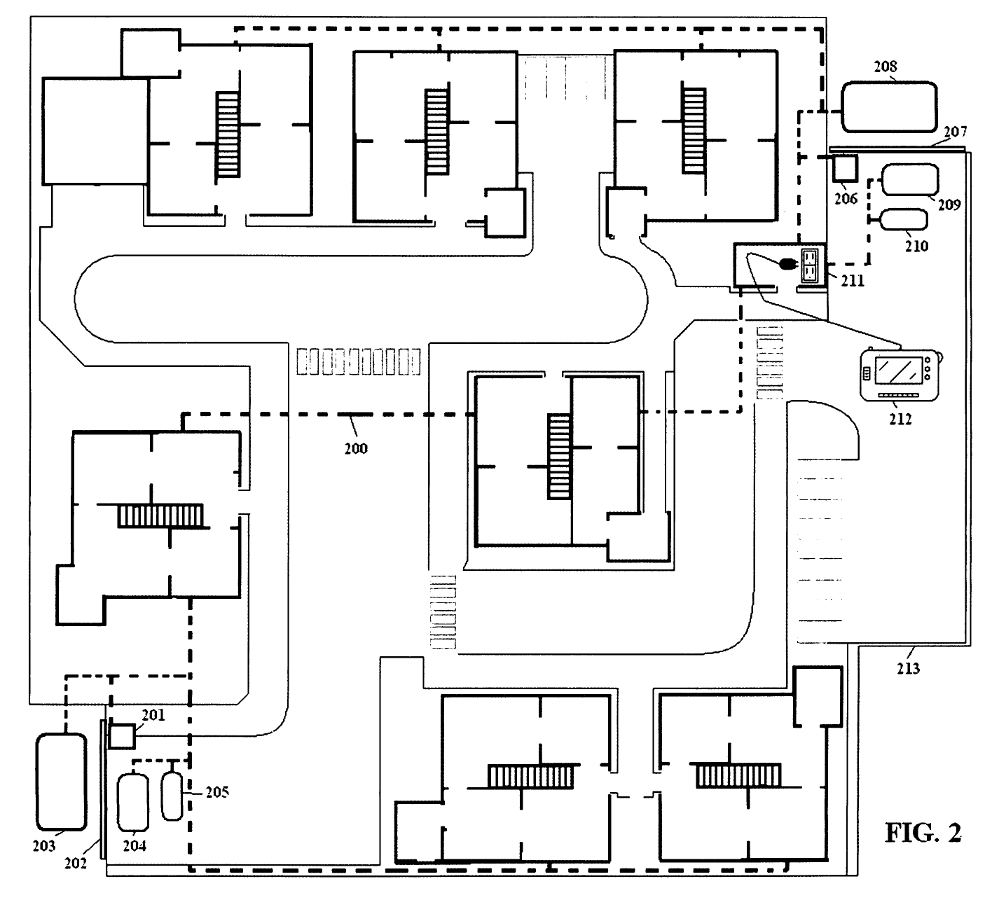

FIG. 2 is an illustration of a basic physical connection in another embodiment of the present invention. Here, a top view of gated community 213 is shown with power grid 200 running power throughout the various units from gate 202 to gate 207.

Here, power grid 200 is depicted as a one long power line throughout gated community 213; however, this is illustrative of an actual power grid in gated community 213.

Power grid 200 links gate operator 201 and its sensors 203, 204, and 205 to gate operator 206 and its sensors 208, 209, and 210.

Like many gated communities, gated community 213 has more than one gate, here gates 202 and 207. By linking each gate operator 201 and 206 via power grid 200, bilateral communication may be achieved using monitoring device 212.

Monitoring device 212 may be connected by accessing utility room 211 located near gate 207. Once monitoring device 212 has achieved communication with both gate operators 201 and 206, and their respective sensors 203, 204, 205, 208, 209, and 210, a technician may begin to monitor, troubleshoot, or adjust the settings for each gate.

For example, a technician may enter utility room 211 and plug in monitoring device 212 to communicate with gate operators 201 and 206, and their respective sensors 203, 204, 205, 208, 209, and 210 via power grid 200. In one embodiment of the present invention monitoring device may then receive information from gate operators 201 and 206 regarding parameters such as: the motor speed in which gate operator 201 moves gate 202; motor voltage used by gate operator 201; gate operator 201's motor current; gate 202's position, i.e. whether gate 201 is in the open position, closed position, in the process of opening, or in the process of closing; internal control board voltages; internal voltage references; power line voltage; battery voltage; and instantaneous consumption current for different devices, such as sensors 203, 204, 205, 208, 209, and 210.

In an exemplary embodiment, monitoring device 212 provides a user, such as a technician, with a graphical representation of these parameters including a graphical representation of a gate moving (during gate movement) from opened to closed positions so that a technician does not have to leave utility room 211 in order to determine whether gates 202 or 207 have been opened or closed. For example, and without departing from the scope of the present invention, a technician in utility room 211 may look to monitoring device 212's display to determine gate 201's parameters such as its maximum opened position. The graphical representation will allow the technician to adjust the opened position to a desired distance from the limit opened position of gate 201. This is desirable in the industry as many customers have different requirements for the use of their gates and technicians are hired to constantly make adjustments. Here, monitoring device 211, allows the adjustment of both gate 201 and gate 206 from one remote location, utility room 211.

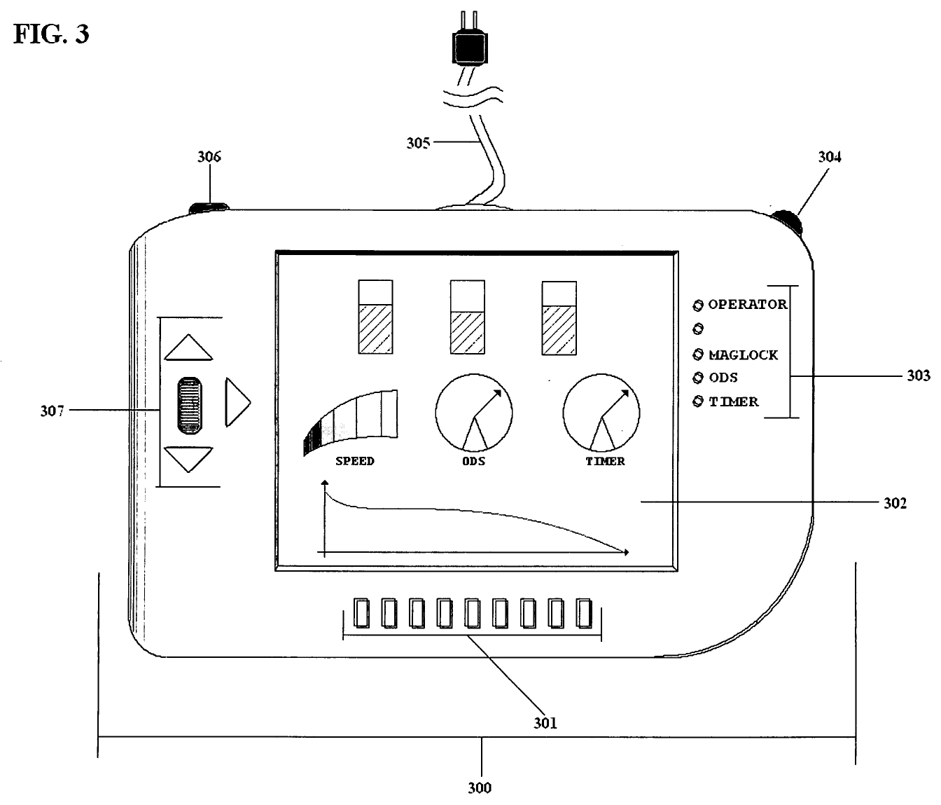

Now turning to FIG. 3, an exemplary embodiment of a gate operator diagnostics monitoring device in accordance with the present invention is illustrated.

Monitoring device 300 comprises of emulation command switches 301, an LCD screen 302, various indicators 303, a turn potentiometer (pot) 304, power cord 305, on/off switch 306, and joystick controller 307.

LCD screen 302 displays information received or stored in monitoring device 300. Of course, any type of display may be implemented without departing from the scope of the present invention. In one embodiment, LCD screen 302 is self illuminating to assist in dark work environments.

Although monitoring device 300 is shown with only one turn pot 304, in another embodiment of the present invention a monitoring device may have multiple pots or a pot array to provide additional functionality.

Power cord 306 extends from monitoring device 300 in order to connect to an available power line. In one embodiment, monitoring device 300 does not include a power cord and can be directly plugged in to an available power socket. In another embodiment, a retractable power cord is implemented in monitoring device 300. In yet another embodiment, a cordless device for accessing a power line may be used with monitoring device 300 without departing from the scope of the present invention.

Although illustrated as a semi-rectangular shape, monitoring device 300 may be shaped in any way without departing from the scope of the present invention. In an exemplary embodiment, however, monitoring device 300 is ergonomically designed for comfort and easy handling of its various controls.

In addition to emulation command switches 301 and turn pot 304, monitoring device 300 has a joystick control 307. These various components allow for a diverse multifunctional input interface for monitoring device 300.

This input interface mentioned immediately above, (i.e. emulation command switches 301, turn pot 304, and joystick control 307) combined with internal components such as a CPU and a memory (discussed in detail below), are monitoring device 300's controller, or control system, that allow a user to receive, process, and send information.

In one embodiment, turn pot 304 may be used to control obstruction sensitivity of a gate operator. In another embodiment turn pot 304 may be used to control time delays for different functions of a gate operator, such as a time delay to close a gate after opening, or a time delay for following a given command to a particular gate operator. In yet another embodiment, a user may designate whether to use turn pot 304, joystick control 307, or any other input device, for a particular function.

Additionally, monitoring device 300 includes a modulator comprised of a power grid interface and PLC circuitry that allows commands from a user to be converted or modulated, and transmitted to other devices, for example a gate operator, connected to a power grid.

The internal components of monitoring device 300, including those components that make up its controller and modulator, are discussed immediately below.

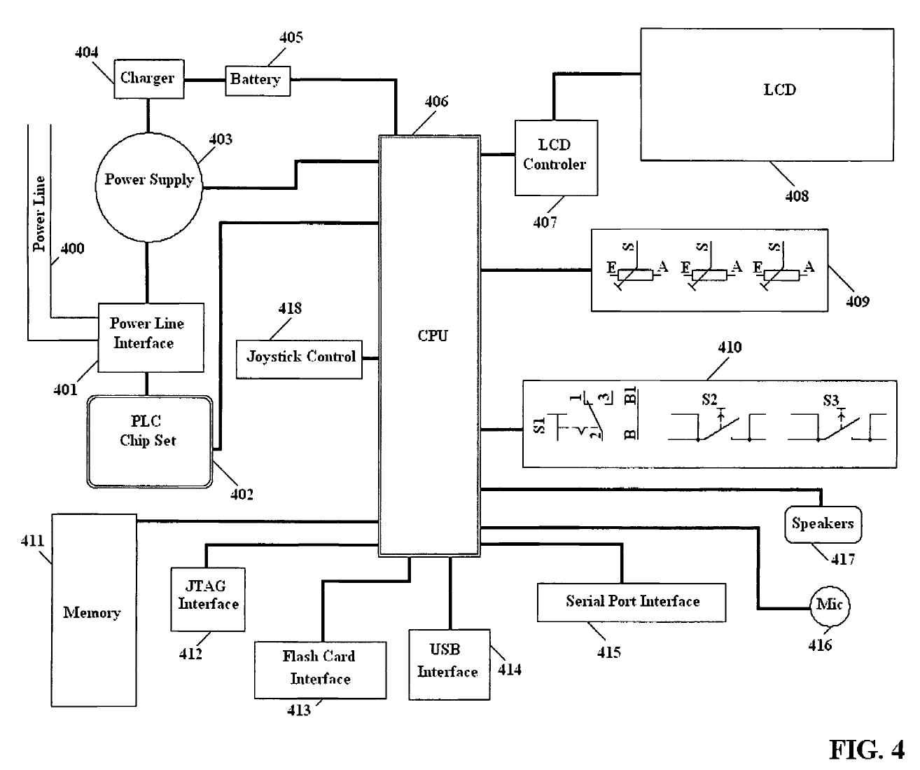

Now turning to FIG. 4, a block diagram of the various components of monitoring device 300 is illustrated.

The schematic of monitoring device 300 comprises of the following components: power line 400, power grid interface 401, PLC circuitry 402, power supply 403, charger 404, battery 405, CPU 406, LCD controller 407, LCD 408, pot array 409, switch array 410, memory 411, JTAG interface 412, flashcard interface 413, USB interface 414, serial port interface 415, microphone 416, speakers 417, and joystick control 418. These various components and their interrelation are now discussed in turn.

Power grid interface 401 derives power from power line 400 and in turn supplies current to both power supply 403 and PLC circuitry 402. Power supply 403 feeds power to various components of monitoring device 300 including charger 404, battery 405, and CPU 406.

Although power supply 403 supplies power to CPU 406, monitoring device 300 can use power supplied by battery 405 in case that a power failure occurs, or monitoring device 300 is not plugged in to a power source such as power line 400. Charger 404 provides the power needed to charge battery 405, which is the back-up power source of monitoring device 300. Thus, in case of a power failure or any time monitoring device 300 is not plugged in to a power source, such as power line 400, battery 405 can supply power to CPU 406.

By communicating with the various components, CPU 406 can control and monitor any PLC capable device plugged in to the same power grid as monitoring device 300 by communicating with PLC circuitry 402, LCD controller 407, pot array 409, switch array 410, memory 411, JTAG interface 412, USB interface 414, serial port interface 415, and joystick control 418.

Along with power grid interface 401, PLC circuitry 402 serves as monitoring device 300's modulator. When receiving information PLC circuitry 402 converts any data received over power line 400 into control signals that can be processed by CPU 406. When sending information, CPU 406 sends control signals to PLC circuitry 402, which can then convert those control signals such that the signals can be transmitted to power grid interface 401 and injected into power line 400. This is accomplished by various modulation techniques.

In one embodiment, PLC circuitry 402 utilizes phase-shift keying modulation to communicate data received from CPU 406 with other devices connected to the same power grid. In another embodiment, PLC circuitry 402 utilizes orthogonal frequency-division multiplexing modulation. In yet another embodiment, PLC circuitry 402 utilizes amplitude-shift keying modulation. And in yet another embodiment, PLC circuitry 402 uses frequency-shift-keying modulation to communicate data received from CPU 406 with other devices connected to the same power grid. This latter method of modulation and demodulation is discussed in greater detail below. However, any other modulation techniques known in the art may be practiced without departing from the scope of the present invention.

CPU 406 communicates with LCD controller to send information to LCD 408. LCD 408 can also be any other type of display without departing from the scope of the present invention.

Pot array 409, switch array 410, and joystick control 418 serve as various input interfaces for users to communicate and send commands to PLC capable devices such as a gate operator linked with monitoring device 300. Numerous potentiometers and numerous switches may be used in an embodiment of the present invention. However, at least one potentiometer may be used in accordance with the present invention for controlling obstruction sensitivity and time delays.

Monitoring device 300 also comprises a memory 411. Memory 411 can include any type of memory known in the art as suitable for applications related to communication with gate operating systems. In one embodiment of the present invention, memory 411 includes read-only memory (ROM), random access memory (RAM), dynamic random access memory (DRAM), FLASH, and Electrically Erasable Programmable Read-Only Memory (EEPROM).

Although monitoring device 300 is illustrated as comprising a JTAG interface 412, a monitoring device not including a JTAG interface would not depart from the scope of the present invention. A JTAG interface 412 may used to troubleshoot, program, or monitor any capable of communication with monitoring device 300. Additionally, this interface can be use to directly program firmware on gate operators once a communication is established.

Flash card interface 413 is desirable because such information as instruction manuals and helpful brochures require massive amount of memory that monitoring device 300 may not have. However, a device in accordance with the present invention may not comprise of a flash card interface or similar component, and yet not depart from the scope of the present invention. Flash card interface 413 can be use to store multiple catalogs, manuals, brochures, and other helpful information that may aide a user such as a technician, when installing or adjusting gate operators in the field.

In one embodiment, monitoring device 300 can be uploaded with an installation manual accessible to a technician for review. For example, and without limiting the scope of the present invention, an installation manual for a gate operator may be displayed for a technician while working with the device in the field. This information may be desirable during installation, maintenance, or adjustment of gate operators.

In one embodiment, flash card interface 413 stores visual and audible step by step instructions for various models of gate operators.

Additionally, monitoring device 300 comprises of a USB interface 414 which may be used to upload or upgrade firmware for monitoring device 300. Again, an embodiment not comprising of any USB interface capabilities does not depart from the scope of the present invention. Furthermore, serial port interface 415 provides yet another connectivity option for monitoring device to hook up to other devices for the transfer of communication.

Finally, monitoring device 300 also comprises of speakers 417 and microphone 416, however a monitoring device in accordance with the present invention does not need to have speakers or a microphone. Speakers 417 and microphone 416 may be useful however, for training of technicians in the field. For example, and without limiting the scope of the present invention, recordings may be made onto monitoring device 300 for other training technicians to follow particular instructions on a particular job site.

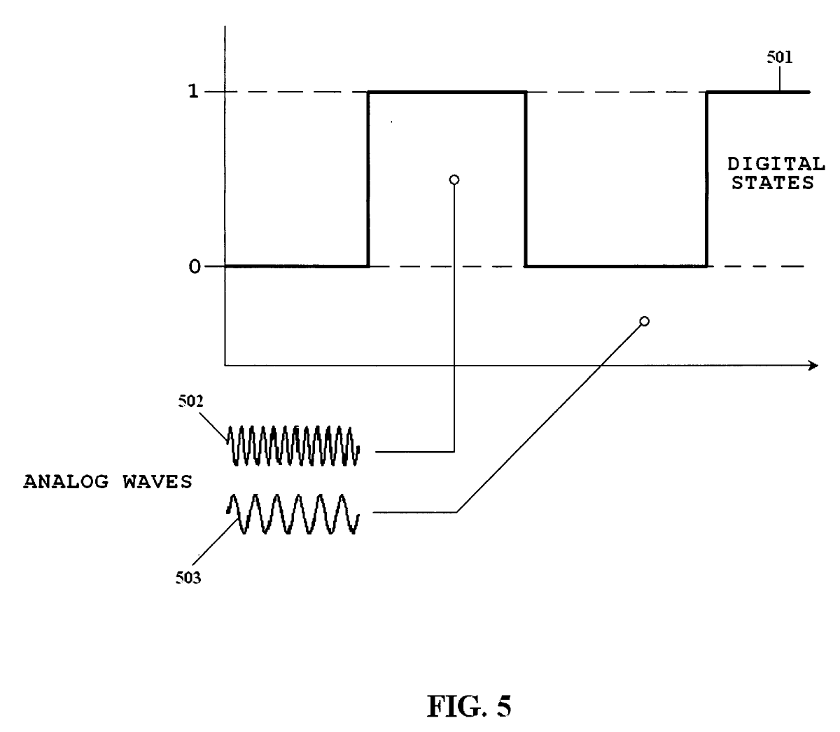

Turning now to FIG. 5, one type of modulation used to send signals over a power line in accordance with an embodiment of the present invention is illustrated.

One of the methods implemented in PLC technologies today involves sending a signal over a power line using frequency-shift keying (FSK) modulation. FSK is a form of frequency modulation in which the modulating signal shifts the output frequency between predetermined values. FIG. 5 shows predetermined values 0 and 1. Frequency-shift keying (FSK) is a method of transmitting digital signals. The two binary states, logic 0 (low) and 1 (high), are each represented by analog waveforms 502 and 503. Logic 0 is represented by a wave at a specific frequency, and logic 1 is represented by a wave at a different frequency. This binary data can be converted to FSK for transmission over telephone lines, cables, optical fiber, and of course, power lines. Incoming FSK signals are then converted to digital low and high states, which a device such as a gate operator configured to communicate using PLC capabilities, can then “understand.”

FIG. 5 shows digital signal 501 consisting of two binary states: logic 0 and logic 1. These logic states are converted into carrier waves in the form of analog signal 502 and analog signal 503. In the illustrated embodiment, an analog signal for logic 1 is given a higher frequency 502 than the analog signal for logic 0 at frequency 503. These signals can be injected into a power line in a band of frequencies not used for the purpose of supplying electricity or managing electricity. A listening device on the power line, e.g. a properly configured gate operator or monitoring device 300, can then demodulate analog signals to read the original digital signal that was sent.

FIG. 5 serves only as an explanation of FSK. Naturally, other types of encoding schemes may be implemented in accordance with the present invention. Other types of modulation may include but are not limited to: orthogonal frequency-division multiplexing, phase-shift keying, amplitude-shift keying and multiple frequency-shift keying.

Since devices such as monitoring device 300 and gate operator 101 may be plugged into regular power outlets in a grid, or may be permanently wired in place via a common power source, it is foreseeable that carrier signals may propagate to other devices on the same power grid.

In an exemplary embodiment, each device's signal is differentiated. This may be accomplished in a number of ways: signals may be transmitted on specific frequencies to distinguish themselves, signals may be prefixed with unique identifiers, or if several devices coexist in a grid, each may be characterized by a different digital signature to distinguish signals that are meant to be received by a particular device.

In an exemplary embodiment, each signal contains a frame that identifies which device sent the signal, which device should receive the signal, a signal, and a checksum.

An apparatus and method for monitoring and controlling gate operators via power line communication has been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching. It is intended that the scope of the invention not be limited by this detailed description, but by the claims and the equivalents to the claims.

What is claimed is:

1. A method for a user to communicate with a movable barrier operator through a power grid comprising the steps of:
connecting a communication unit to said power grid to communicate with said movable barrier operator;
receiving a command signal from said user;
deriving a control signal from said command signal from said user; and
modulating a power line signal to carry said control signal to said movable barrier operator over said power grid.

2. The method of claim 1, wherein said step for modulating a power line signal utilizes frequency shift keying modulation.

3. The method of claim 1, wherein said step for modulating a power line signal utilizes phase-shift keying modulation.

4. The method of claim 1, wherein said step for modulating a power line signal utilizes orthogonal frequency-division multiplexing modulation.

5. The method of claim 1, wherein said step for modulating a power line signal utilizes amplitude-shift keying modulation.

6. The method of claim 1, wherein said movable barrier operator is a gate operator.

7. The method of claim 1, further comprising
receiving a response signal from said movable barrier operator carrying a data responsive to said control signal over said power grid; and
demodulating said response signal and displaying said data on said communication device.

8. The method of claim 7, wherein said response signal from said movable barrier operator further comprises of a signal from a sensor connected to said movable barrier operator.

9. The method of claim 7, wherein said communication unit and said movable barrier operator are connected to a common power grid.

10. The method of claim 9, wherein said communication unit monitors and controls said movable barrier operator that is connected to said power grid.

11. The method of claim 10, wherein said communication unit diagnosis and analyzes an operation of said movable barrier operator that is connected to said power grid.

12. The method of claim 11, wherein said communication unit is used to adjust a parameter of said movable barrier operator that is connected to said power grid.

13. The method of claim 12, wherein said communication unit is used to upgrade a software of the movable barrier operator that is connected to said power grid.

14. An apparatus for communicating with a movable barrier operator through a power grid comprising:
a power grid interface to connect said apparatus to said power grid;
a first circuitry configured to receive a command signal;
a controller to derive a control signal from said command signal; and
a second circuitry configured to modulate a power line signal to carry said control signal to said movable barrier operator over said power grid.

15. The apparatus of claim 14, wherein said controller receives a response signal from said movable barrier operator carrying a data responsive to said control signal over said power grid.

16. The apparatus of claim 15, wherein said second circuitry demodulates said response signal.

17. The apparatus of claim 16, wherein said apparatus and said movable barrier operator are connected to a common power grid.

18. The apparatus of claim 16, further comprising:
a display configured to present said data in a graphical and an alphanumerical format.

19. The apparatus of claim 18, wherein said data further comprises a set of information from a sensor connected to said movable barrier operator.

20. The apparatus of claim 19, wherein said data further comprises a power line voltage of the movable barrier operator.

21. The apparatus of claim 20, wherein said data further comprises a battery voltage of the movable barrier operator.

22. The apparatus of claim 21, wherein said data further comprises an internal control board voltage from a power supply.

23. The apparatus of claim 22, wherein said data further comprises an internal reference voltage said power supply.

24. The apparatus of claim 23, wherein said data further comprises an instantaneous consumption current of an internal device.

25. The apparatus of claim 24, wherein said data further comprises a motor voltage, current, speed, and position.

26. The apparatus of claim 16, wherein said display is self illuminated.

27. The apparatus of claim 26, further comprising:
an internal storage for retrieval and display of a preloaded installation instruction manual.

28. The apparatus of claim 27, wherein the preloaded installation instruction manual includes an installation steps, a drawing, a dimension, and a set of procedures.

29. The apparatus of claim 26, wherein a USB interface is connected to the controller to allow for software upgrades.

30. The apparatus of claim 29, wherein a flash card interface is connected to the controller for expandable memory.

31. The apparatus of claim 30, wherein a JTAG interface is connected to the controller for troubleshooting.

32. The apparatus of claim 31, wherein a speaker is connected to the controller.

33. The apparatus of claim 32, wherein a microphone is connected to the controller.

34. A monitoring device for a user to communicate with a movable barrier operator through a power grid comprising:
a power grid interface to connect said monitoring device to said power grid;
a first circuitry configured to receive a command signal from said user;
a controller for:
deriving a control signal from said command signal, and
receiving a response signal from said movable barrier operator carrying a data responsive to said control signal over said power grid;
a second circuitry configured for:
modulating a power line signal to carry said control signal to said movable barrier operator over said power grid, and
demodulating said response signal; and
a display configured to present said data in a graphical and an alphanumerical format,
wherein said data further comprises of a set of information from a sensor connected to said movable barrier operator.
